(19) United States
(12) Patent Application Publication
(10) Pub. No.: US 2012/0203785 A1
(43) Pub. Date: Aug. 9, 2012

(54) ITEM AND USER TRACKING

(75) Inventor: Mariam Awada, Southfield, MI (US)

(73) Assignee: NANOMEDAPPS LLC, Bloomfield Hills, MI (US)

(21) Appl. No.: 13/502,168

(22) PCT Filed: Oct. 15, 2010
(86) PCT No.: PCT/US10/52891

§ 371 Date: Apr. 16, 2012

Related U.S. Application Data
(60) Provisional application No. 61/252,528, filed on Oct. 16, 2009.

(51) Int. Cl. G06F 17/30

(52) U.S. Cl. 707/740; 707/E17.046

(57) ABSTRACT

A computer system is used for tracking data, the computer system including a data collection system for identifying events of categories such as reception events, storage events, and association events. The system further includes an item module containing index data for an item. The system further includes an end user facility module for recording the reception events that are to be assigned to the item and the storage events that are to be assigned to the item. The system further includes a provider module for assigning the association events to a provider. The system further includes an end user module for recording the association events that are to be assigned to the end user and to the item. The system further includes a reporting system for generating reports. The item has a unique index value and the end user has a non-unique index value.

### CROSS-REFERENCE TO RELATED APPLICATIONS

This application claims priority from U.S. Provisional Application Ser. No. 61/252,528, filed Oct. 16, 2009.

### TECHNICAL FIELD

This application relates to the field of database management.

### BACKGROUND

Tools, structures, products, and objects used by end users come in a wide variety of categories, shapes, sizes, prices, and uses. Such items are manufactured and distributed by manufacturers and distributors. In some cases, the manufacture and distribution of such items are closely controlled and regulated to ensure high quality and reliable final products.

Items such as medical devices, for example, are used by medical care providers in the course of providing care to patients. In some instances, an item is a medical device (e.g., a cardiac, orthopedic, or cosmetic device) that can be surgically implanted in a patient. In other cases, an item is used by a medical care provider while interacting with a patient. For example, an item that is a medical device can be used for monitoring a patient such as with a medical imaging or sensing machine.

In return for an item, or for a service that may include the use of one or more items, an individual may pay the provider of the item(s). In some cases, an individual pays the provider directly, either at the time that the item is received by or provided to the individual, or later in response to receiving a bill. In some cases, such as when an item is a medical device, the patient may be covered by medical insurance that pays some or all of the bill for medical services.

### SUMMARY

In general, this document describes a system and method for tracking an item.

In one aspect, a computer system is used for tracking data, the computer system being implemented in computer-readable medium and processor executed, the computer system includes a data collection system for identifying events of categories includes reception events, storage events, and association events. The system further includes an item module containing index data for an item. The system further includes an end user facility module for recording the reception events that are to be assigned to the item and the storage events that are to be assigned to the item. The system further includes a provider module for assigning the association events to a provider. The system further includes an end user module for recording the association events that are to be assigned to the end user and to the item. The system further includes a reporting system for generating reports includes information from at least two of the categories. The item has a unique index value and the end user has a non-unique index value. The system further includes wherein at least the end user facility module, the provider module, and the end user module are communicably coupled to each other in the computer system by a computer network.

Implementations can include any, all, or none of the following features. The computer system includes a manufacturer module for recording the manufacturing events that are to be assigned to the item; wherein the reporting system generates reports including information from at least one of the categories and a manufacturing event; and wherein the manufacturing module is communicably coupled to the computer network. The item is a medical device. The computer system including a distributor module for recording distribution events that are to be assigned to the item; wherein the reporting system generates reports including information from at least one of the categories and a distribution event; and wherein the distributor module is communicably coupled to the computer network. The end user's non unique index includes demographic information. The item's unique index includes a model number and serial number. The end user facility module is associated with one or more of a hospital, clinic, or health care office. The provider module is associated with a health care provider. The end user is a medical patient.

In one aspect, a method is used for tracking data, the method being implemented in computer readable medium and processor executed, the method includes identifying, by a data collection system, events of categories includes reception events, storage events, and association events. The method further includes accessing, from an item module, index data for an item. The method further includes recording, by an end user facility module, the reception events that are to be assigned to the item and the storage events that are to be assigned to the item. The method further includes assigning, by a provider module, the association events to a provider. The method further includes recording, by an end user module, the association events that are to be assigned to the end user and to the item. The method further includes generating, by a reporting system, reports includes information from at least two of the categories. The method further includes wherein the item has a unique index value and the end user has a non-unique index value. The method further includes wherein at least the end user facility module, the provider module, and the end user module are communicably coupled to each other in the computer system by a computer network.

Implementations can include any, all, or none of the following features. The method including recording, by a manufacturer module, the manufacturing events that are to be assigned to the item; generating, by a reporting system, reports including information from at least one of the categories and a manufacturing event; and wherein the manufacturing module is communicably coupled to the computer network. The item is a medical device. The method includes recording, by a distributor module, distribution events that are to be assigned to the item; generating, by a reporting system, reports including information from at least one of the categories and a distribution event; wherein the distributor module is communicably coupled to the computer network. The end user's non unique index includes demographic information. The item's unique index includes a model number and serial number. The end user facility module is associated with one or more of a hospital, clinic, or health care office. The provider module is associated with a health care provider. The end user is a medical patient.

In one aspect, a computer program product is tangibly embodied in a computer readable storage medium and includes instructions that when executed by a processor perform a method includes identifying, by a data collection system, events of categories includes reception events, storage events, and association events. The computer program product further includes accessing, from an item module, index data for an item. The computer program product further includes recording, by an end user facility module, the reception events that are to be assigned to the item and the storage events that are to be assigned to the item. The computer program product further includes assigning, by a provider module, the association events to a provider. The computer program product further includes recording, by an end user module, the association events that are to be assigned to the end user and to the item. The computer program product further includes generating, by a reporting system, reports includes information from at least two of the categories. The computer program product further includes wherein the item has a unique index value and the end user has a non-unique index value. The computer program product further includes wherein at least the end user facility module, the provider module, and the end user module are communicably coupled to each other in the computer system by a computer network

Implementations can include any, all, or none of the following features. The method including recording, by a manufacturer module, the manufacturing events that are to be assigned to the item; generating, by a reporting system, reports including information from at least one of the categories and a manufacturing event; and wherein the manufacturing module is communicably coupled to the computer network. The item is a medical device. The method includes recording, by a distributor module, distribution events that are to be assigned to the item; generating, by a reporting system, reports including information from at least one of the categories and a distribution event; wherein the distributor module is communicably coupled to the computer network. The end user's non unique index includes demographic information. The item's unique index includes a model number and serial number. The end user facility module is associated with one or more of a hospital, clinic, or health care office. The provider module is associated with a health care provider. The end user is a medical patient.

Unless otherwise defined, all technical and scientific terms used herein have the same meaning as commonly understood by one of ordinary skill in the art to which this invention pertains. Although methods and materials similar or equivalent to those described herein can be used to practice the invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 shows an exemplary system for tracking an item and tracking a user of the item.

FIG. 2 shows an exemplary computing cloud for storing data related to items.

FIGS. 3A and 3B show an exemplary listing of actors in an item and user tracking system.

FIG. 4 is a flow chart showing an example process of recording information related to an item.

FIG. 5 shows an exemplary report displaying medical information.

FIG. 6A shows an exemplary graphical user interface for setting input access levels.

FIG. 6B shows an exemplary graphical user interface for setting output access levels.

FIG. 6C shows an exemplary graphical user interface for setting centralized access levels.

FIG. 6D shows an exemplary graphical user interface for setting security access levels.

FIG. 7 is a flow chart showing an example process of adding new data to a tracking system.

FIG. 8A shows an example of a computing device and a mobile computing device that can be used in connection with computer-implemented methods and systems described in this document.

FIG. 8B shows and alternative example of a computing device and a mobile computing device that can be used in connection with computer-implemented methods and systems described in this document.

FIG. 9 shows a computer system for collecting data from record holders to a data repository.

FIG. 10 shows a computer system for providing information from a data repository to user portals.

Like reference symbols in various drawings indicate like elements.

### DETAILED DESCRIPTION

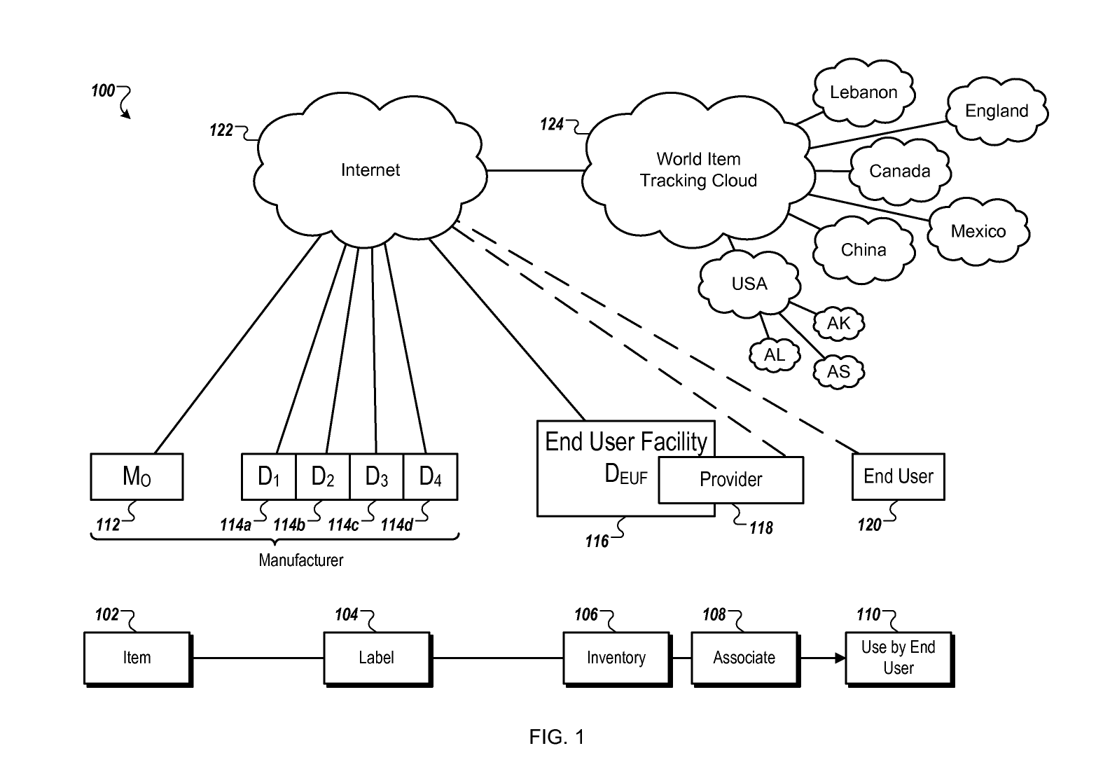

FIG. 1 shows an exemplary system for tracking an item, the manufacture, distribution, association and user of the item. An item tracking system 100 can track an item 102 through stages of the item's 102 manufacture, distribution, and use. The item tracking system 100 can be a world health knowledge actions system capable of tracking items, preventing or reducing adverse reactions, generating group data to identify problems with item manufacture or use, or other uses.

In some implementations, the system 100 can relate to database management, server definition of databases, creating maintaining mandatory and anything related to and data for which pertaining to any data created through data management including data in the database and data related to use of the system data management produced specific to that user. For example, a regulatory body will access data irrespective of patients or patient related data warehouse information. The system 100 can be used for not only tracking and not only items and users. For example, manufactures and distributors.

The item 102 can be a device used with, on, about, or related to an end user. In some implementations, the item 102 can be a food, drug, and/or medical device as defined by section 201(h) of the Federal Food Drug & Cosmetic (FD&C) Act:
“[A]n instrument, apparatus, implement, machine, contrivance, implant, in vitro reagent, or other similar or related article, including any component, part, or accessory, which is—
(1) recognized in the official National Formulary, or the United States Pharmacopeia, or any supplement to them,
(2) intended for use in the diagnosis of disease or other conditions, or in the cure, mitigation, treatment, or prevention of disease, in man or other animals, or
(3) intended to affect the structure or any function of the body of man or other animals, and which does not achieve its primary intended purposes through chemical action within or on the body of man or other animals and which is not dependent upon being metabolized for the achievement of its primary intended purposes.”

Example items 102 include, but are not limited to, automobile parts, gps locators, insurance policies, equipment, biological, blood and cellular products, drugs CTC, food, prescription drugs, cosmetics, diagnostic equipment, instruments (surgical/medical), diagnostic reagents, electromedical apparatus, electrotherapeautic apparatus, radiation apparatus, laboratory apparatus, furniture, equipment, appliances, consumer products, industrial goods, and other items that may be purchased or distributed on a market.

The item 102 can be manufactured, underwritten, sterilized, sorted, packaged, labeled 104 and/or otherwise undergo process by a manufacture system composed of multiple components. The item 102 can be stored as inventory 106 in preparation for purchase, prescription, implantation, assignment and/or association 108 for use by an end user 110.

An original manufacturer 112 can be a manufactory, factory, producer, or other actor that can create the base item 102, for example from raw components. Distributors 114 can receive the item and perform a process on or with the item, such as labeling 104. In some implementations, different distributors 114 can perform different process. The distributor 114a, for example, can sterilize and prepackage the item 102; the distributor 114b, for example, can print documentation to be included with the item 102; the distributor 114c, for example, can package and label the item 102; the distributor 114d, for example, can group and crate the item 102 with other items for overseas shipping; and other processes are possible. In some implementations, two or more distributors 114 can perform the same processes at different stages. For example, such processes known as labeling can be recorded at distributors 104a, 104b, and 104c. In some

An end user facility 116 can be a special type of distributor 114. The end user facility 116 can be a salesperson, agent, hospital, clinic, and/or other facility where the item 102 is stored. Example medial related end user facilities 116 include, but are not limited to, hospital, operating room, emergency room, patient unit, Xray department, laboratory, emergency vehicle, health care mobile unit/vehicle, critical care facility, nursing home, clinic, ambulatory surgery center, dental office, chiropractic center, podiatry center, provider facility, distributor of medical devices, equipment, products, services, radiology facility, anesthetic facility, intermediate, short or long term care facility, physical and medical rehabilitation facility, dialysis center, infusion center, out patient provider center, in patient provider center, radiation treatment center, pain clinic, physician office, and/or pharmacy.

A provider 118 can associate the item 102 with an end user 120. In some examples, the provider 118 can be a doctor, dentist, nurse, or other health care provider. In some examples, the end user can be a patient receiving medical services from the provider 118. In one implementation, a surgeon provider 118 can implant a cosmetic, orthopedic, cardiac or other implant in a patient end user 120. In another implementation, a nurse provider 118 can provide a pair of crutches to an end user 120 with a sprained ankle Example providers 118 include, but are not limited to salesperson, agent, correctional officer, doctor, dentist, pharmacist, hospital provider, hospital services, hospital employee, surgeon, specialist, operating room assistant, operating room employee, emergency room provider, emergency room services, emergency room employee, patient unit provider, patient unit services, patient unit employee, patient unit surgeon, patient unit end user provider, patient unit assistant to end user, radiologist, radiology provider, radiology surgical provider, radiology staff, radiology personal, radiology professional, radiology assistant user, radiology installer, radiology assistant, radiology employee, radiology technician, radiology administrator, radiology equipment provider, radiology equipment counter, radiology provider end user assistant, laboratory provider, laboratory expert, laboratory specialist, laboratory professional, laboratory operator, laboratory technician, laboratory surgeon, laboratory installer, laboratory assistant to end user, laboratory staff, emergency vehicle provider, emergency vehicle responder, emergency vehicle operator, emergency vehicle technician, emergency response team member, emergency response team responder, emergency response team provider, emergency response team operator, emergency response team physician, mobile heath care unit provider, mobile heath care unit operator, mobile heath care unit servicer, mobile heath care unit technician, mobile heath care unit specialist, mobile heath care unit equipment provider, mobile health care unit services, mobile health care unit technician, critical care provider, critical care facility provider, critical care facility member, critical care facility assistant, critical care facility employee, critical care facility agent, critical care facility director, critical care facility listed agent, critical care facility authorized agent, critical care facility registered agent, critical care facility approved provider, critical care facility authorized provider, critical care facility registered provider, critical care facility certified provider, critical care facility accredited provider, critical care facility legal provider, critical care facility qualified provider, pharmacist, pharmacy provider, pharmacy technician, pharmacy specialist, pharmacy operator, pharmacy expert, pharmacy professional, pharmacy services, pharmacy employee, pharmacy installer, pharmacy administration, pharmacy assistant to end user, pharmacy consultant to end user, pharmacy adverse reaction module user, pharmacy purchases, pharmacy utilities, pharmacy conscience administrator, and/or pharmacy end user provider.

In some configurations, the provider 118 can be associated with the end user facility 116. In one implementation, a provider can practice out of a group clinic. In some configurations, the provider 118 can be independent of the end user facility 116, in which case the end user facility 116 can function like a distributor 114. For example, a private practice physician provider 118 can run a small practice that does not routinely stock many items, but the private practice physician provider 118 can order the item 102 as needed from the appropriate distributor 114 as needed. In another implementation, a salesperson can receive an order from a customer, an agent can determine an insurance policy, or a correctional officer can assign a GPS tracking bracelet to an inmate.

The original manufacturer 112, the distributors 114, the end user facility 116, the provider 118, and the end user 120 can report to a world item tracking cloud 124 via a network 122 such as the Internet. Computing clouds, as used here, are abstractions of underlying computer infrastructure. As the original manufacturer 112, the distributors 114, the end user facility 116, the provider 118, and the end user 120 receive, ship, or otherwise handle the item 102, information about the handling can be reported to the world item tracking cloud 124. Additional information such as date, time, associated people and/events, and other data can also be reported to the world item tracking cloud 124. In one implementation, the world item tracking cloud 124 can be a computer system that includes sub-systems of national item tracking clouds, which can be composed of state and/or providence level item tracking clouds. The national and state item tracking clouds can be communicably intraconnected and/or interconnected, in order to track data related to items that move within and between states and nations.

In some implementations, information can be entered into a computer system such as a web browser or database application. In some implementations, a barcode can be scanned, or a radio frequency identification (RFID) tag can be sensed, and the information about the sensing or scanning and information about the sensor or scanner can be sent to the world item tracking cloud 124. For example, the original manufacturer 112 can create the item 102 and store the item 102 in a box with a quick response (QR) bar code. Before the item 102 is shipped, the original manufacturer 112 can scan the QR bar code with a scanner that has stored location, time, and manufacturing information. The scanner can send information to the world item tracking cloud 124. Later in this example, the end user facility 116 can receive a shipment including the item 102 and a RFID tag associated with the item 102. The end user facility 116 can scan the shipment, detect the RFID tag, and report to the world item tracking cloud 124.

In some implementations, the item tracking system 100 can provide functionality to facilitate electronic emergency preparedness and response; regulation, tracking, and reporting; health and safety monitoring; financial functions such as automatic payments for services and other e-commerce; shelf life and warranty tracking based on lot, manufacturer or item listing, or serial number; analysis of items including outcomes, effectiveness, and prevention of adverse reactions.

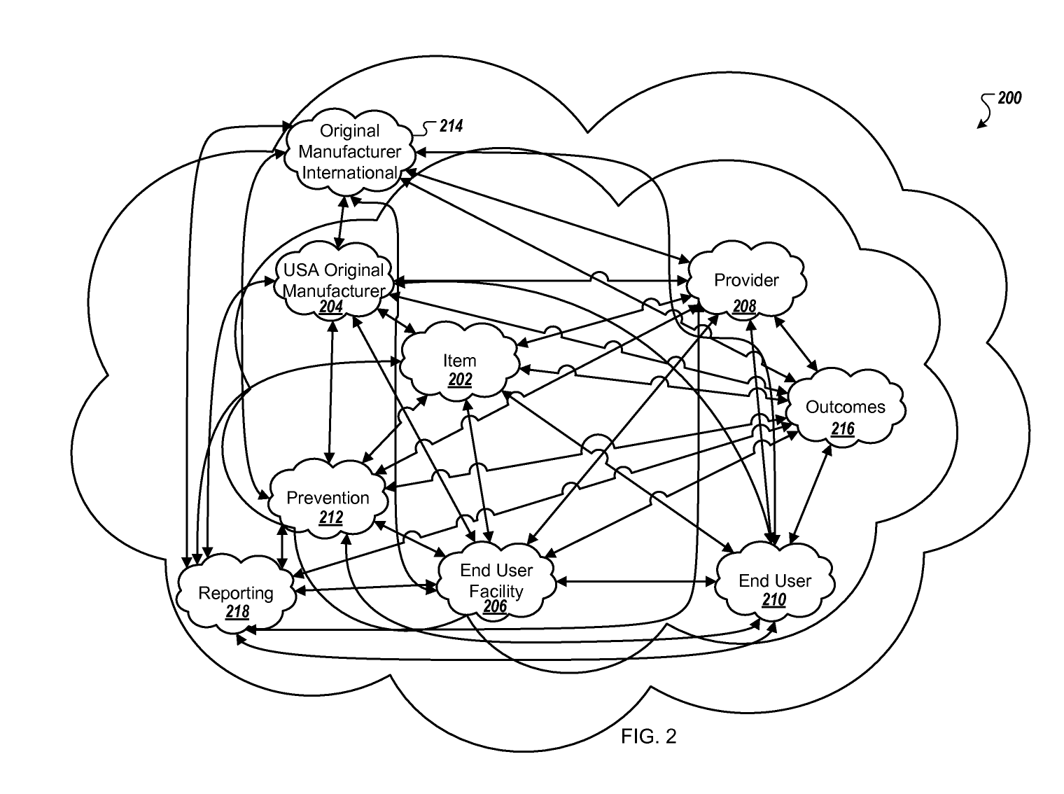

FIG. 2 shows an exemplary computing cloud 200 for storing data related to items, such as medical devices. In some implementations, the cloud 200 can be used as a national, state, or county level item tracking cloud in the world item tracking cloud 124, for example for tracking medical devices for the United States, Michigan, or Wayne County.

In some implementations, a computing cloud can be a logical, as opposed to mechanical, representation of a computer system that defines data and/or functionality in the system, but not the hardware, programs, or details of how the data and/or functionality are provided. It will be understood by one skilled in the art that the choices of hardware, programs, and details can be selected based on factors such as price, scalability, reliability, and availability, using methods known in the art. An item cloud 202 can be a cloud used to store data related to items such as medical devices. In some implementations, information received from an item manufacturer, distributor, end user facility, provider, or end user can be stored in the item cloud 202.

An original manufacturer cloud 204 can be a cloud used to store data related to device manufacturers. In some implementations, this information can include a manufacture's name and contact information, a listing of all physical locations owned by the manufacturer, a listing of the types of items produced by that manufacturer, and/or other information.

A distributor/end user facility 206 can be a cloud used to store data related to distributors and/or end user facilities that can handle items. In some implementations, this information can include the date an item is received or shipped, processes that are applied to an item, and/or other information.

A provider cloud 208 can be a cloud used to store data related to a medical care provider. In some implementations, this information can include data and medical records related to an action taken by the medical care provider using an item. Additional information can include the medical care provider's biographical information, licensing information, billing information, appointment information, and/or other data.

An end user 210 can be a cloud used to store data related to an end user and/or patient associated with an item. In some implementations, this information can include the end users' contact information, financial information, biographical information, demographical information, geographical information, and/or other data.

A prevention cloud 212 can be a cloud used to store and determine adverse reactions between an end user and an item. In some implementations, when an item is assigned to an end user, the prevention cloud 212 can examine data related to the item and data related to the end user to determine if there are any possible or likely adverse reactions associated with the potential use.

In some implementations, information related item manufacture outside of the United State's borders can be recorded in an original manufacturer international cloud 214. Due to the variances in laws and practices, additional original manufacturing international clouds can be associated with a single or group of international countries. The information in the original manufacturer international cloud 214 can be associated with related information in the original manufacturer cloud 204. For example, a foreign manufacturer can retain an agent in the United States for purposes of domestic sales and marketing. It will be understood that in computing clouds for other nations, additional or different original manufacturer and original manufacturer international clouds can be used to meet the requirements of those nation's laws and practices.

An outcomes cloud 216 can be a cloud used to store information regarding the outcome of a medical procedure, course of drug therapy, or other activity recorded in the computing cloud 200. In one example, a drug, whose information is tracked in the item cloud 202, can be prescribed to a test population of one hundred patients, whose information is tracked in the end user 210. The drug can be prescribed by a single provider whose information is tracked in the provider cloud 208. The drug can be manufactured in a foreign country, and the information related to the manufacturer and local agent can be tracked in the original manufacturer cloud 204 and the original manufacturer international cloud 214. After the one hundred patients have been prescribed the drug, information about the results will be tracked in the end user 210 as part of the normal course of monitoring the test. As the test progresses, results are monitored and aggregated in the outcomes cloud 216.

A reporting cloud 218 can be a cloud that communicates reports to computer systems, including computer systems outside of the cloud 200. For example, reorder requests, insurance claims, electronic bills, and communications with external or legacy medical record systems can be handled by the reporting cloud 218. Each report can include information from one or more events from the system 200.

Data in the clouds 202-212 can be interrelated and intrarelated to data in other clouds 202-212. In some implementations, data in different clouds can be organized and associated with codes, and those codes can be used to find the related data. For example, an original manufacturer's data can be stored in the original manufacturer cloud 204 with a particular code associated therewith. Data related to items created by that manufacturer can be stored in the item cloud 202 with the same associated code. Using this particular code, the manufacturer of a device or devices created by a manufacturer can be identified.

In some alternative embodiments, for example one unrelated to medical devices and optionally without the prevention cloud 212, the cloud 200 can be used to track food items, automobile parts, housing, movies, telecommunications, money, energy, entitlements, insurance policies, newborn infants, GPS locators, ecommerce, and egovernment.

Some of the data stored in the cloud 200 can be created by health care providers or other users using dictation interfaces. For example, a remote provider, affiliated with a medical center or not, can dictate medical information to a computer, and the computer can analyze the dictation to generate text for the medical record. [[for example, a patient home provider who is caring for the patient can directly upload to medical health record]]

Some of the data stored in the cloud 200 can be created by medical imaging and sensing devices. For example, an MRI machine can generate a medical image, which can be associated with a provider, an end user facility, and or an end user.

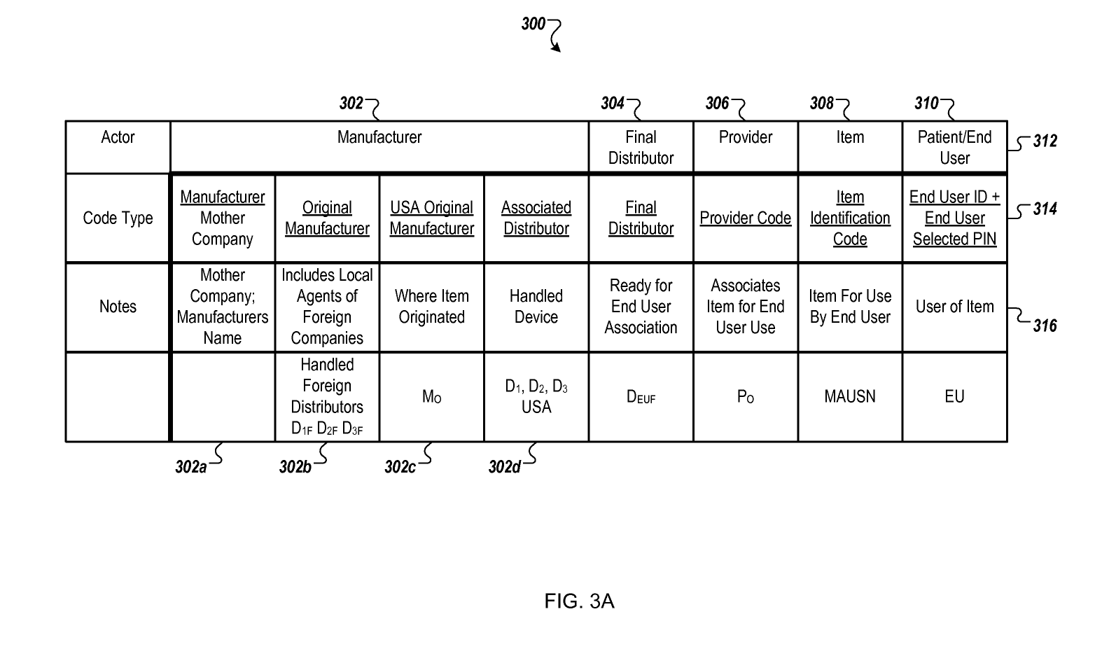

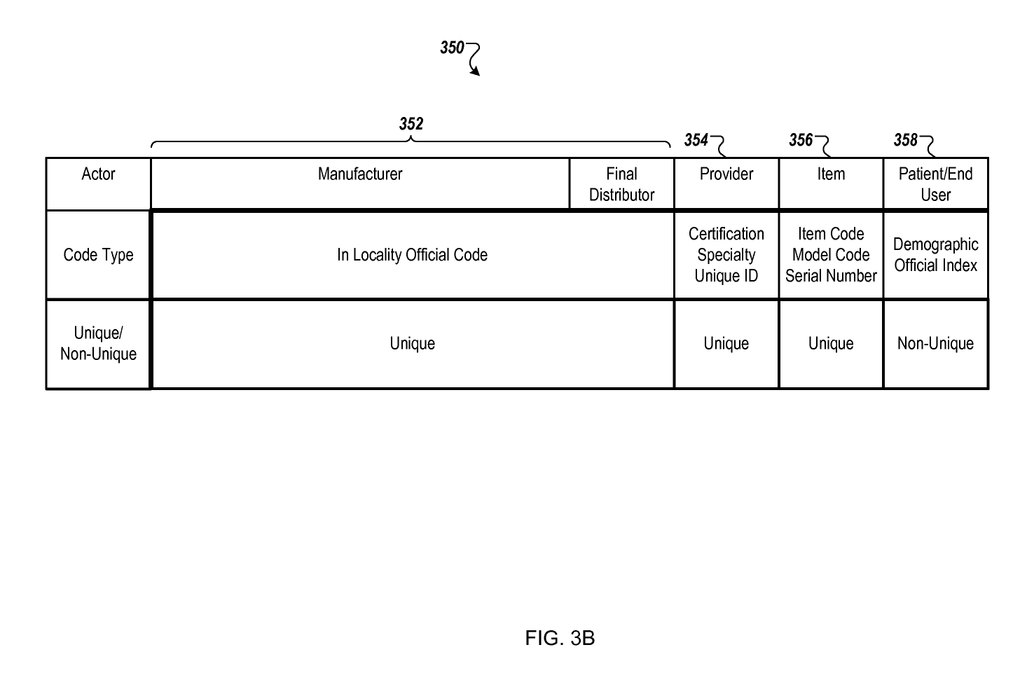

FIG. 3A shows an exemplary listing 300 of actors and associations in an item and user tracking system with individual personal identification number (PIN) control. For example, the listing 300 can demonstrate criteria for codes or keys used to uniquely or nonuniquely identify and locate data and records related to actors, or used as passwords to access such data. Alternatively, the codes or keys may be used to describe entities uniquely or non-uniquely indexed by other data. It will be understood by one skilled in the art that these codes can be used alone or in conjunction with additional data such as random or sequential data, data collected or recorded from environments reflective of time and space, and other data.

Actors 312 can include a list of possible actors related to an item that can be tracked. Code types 314 can include the type of code assigned to an actor. Notes 316 can include additional ancillary information related to other entries in the same column.

A manufacturer 302 can be an actor responsible for initial creation of an item. The manufacturer 302 can include a manufacturer 302a, such as a name or title of the company that owns or operates a manufacturing facility. The manufacturer 302 can include an original manufacturer 302b, such as location information or identification of a local agent. The manufacturer 302 can include a USA original manufacturer 302c for items manufactured domestically. In some systems, such as the regulations used by some government agencies, a manufacturer 302 is considered to include distributors 302d, even when those distributors are wholly independent organizations separate from the original manufacturer 302b.

A final distributor 304 can be a special case of the distributors 302d. The final distributor 304 can be a distributor 302d that provides an item to a provider 306. A provider 306 can be an actor that associates an item with an end user 310. Example associations are prescriptions, assignments, implantations, and ordering.

The parent company 302b, the manufacturer location 302c, the distributor 302d, and the final distributor 304 codes can be codes based in part on codes which are used by other organization such as those used by the Health Industry Business Communications Council (HIBCC), United Nations Standard Products and Services Code (UNSPSC), National Drug Code (NDC), SG1, VACS, Universal Medical Device Nomenclature System (UMDNS), Healthcare Common Procedure Coding System (HCPC), and/or by commerce and regulators.

A provider 306 code can be assigned to a doctor, nurse, or caregiver and assigned to any item used, prescribed, implanted, or otherwise utilized by the provider 306. The provider 306 code can be a code based in part on codes used by a licensing body—such as a state medical licensing organization with expiration date—code assigned the provider 306.

The item 308 can have a unique code created and assigned by the parent company 302b. If every parent manufacturer 302b code is unique and every item 308 code is unique for that parent manufacturer 302b, every item 308 can be uniquely identified.

An end user 310 can be a patient or other person using the item 308. For example, an end user 310 can receive a surgical implant item 308. In some implementations, the end user 310 code can be a code based partly on geographic information (for example zip code or telephone area code), demographic data (for example race, age, and/or date of birth), or other data. In other implementations, the end user 310 code can be independent of any factors related to the end user 310. The end user 310 code can also include patient PIN or other password. This PIN or password can be used by the end user 310 to ensure privacy and security of personal information.

FIG. 3B shows an exemplary listing 350 of actors and associations in an item and user tracking system with individual personal identification number (PIN) control. In the example listing 350, some data entries are unique and some data entries are non-unique. The listings 350 can be used to catalog the entities described in the listings 300 in a data repository.

Manufacturers and final distributors 352 can be uniquely identified by official codes used to index entities in a particular regional area. For example, codes based in part on codes which are used by organization such as those used by the Health Industry Business Communications Council (HIBCC), United Nations Standard Products and Services Code (UNSPSC), National Drug Code (NDC), SG1, VACS, Universal Medical Device Nomenclature System (UMDNS), Healthcare Common Procedure Coding System (HCPC), and/or by commerce and regulators can be assumed to be unique for each manufacturer and final distributor indexed, and those codes can be used to uniquely index such entities in a data repository.

Providers 354 can be uniquely identified by a combination of three data fields: certification, specialty, and a unique identification. A certification field can specify the type or types of certification, degree, license, or accreditation associated with the provider 354. A specialty categorization can identify a specialization or area of practice associated with the provider 354. A unique identification number can be associated with the provider 354. The combination of the certification, specialty, and unique identification can be used as a single index for each provider in a data repository. Items 356 can be uniquely identified by a combination of three data fields: item code, model code, and serial number. An item code can be an official code used to categorize the item based on use or structure In some implementations, all manufacturers 352 share the same item code designation rules, such that similar items made by different manufacturers share the same item codes. A model number can be assigned to a particular model of item by the items' manufacturer. In some implementations, some or all manufacturers do not share the same the same model code designation rules, and different models of different or similar products made by the different manufacturers may have the same model number. However, in some implementations, no two models of items with the same item code may have the same model number. A serial number may be assigned to each item of a model by the item's manufacturer. In some implementations, each serial number may be unique only to a particular model code and item code combination.

Although none of the item code, model code, and serial number may be universally unique for all items, the combination of any particular item code, model code, and serial number may be unique for each item, and this combination can be used to uniquely index each item in a data repository.

End users 358 may be non-uniquely identified in a data repository. In some implementations, official documentation of end users and/or the population in general may be incomplete, inaccurate, and/or unreliable. Demographic data can be collected for each end user 358, for example according to International Organization for Standardization (ISO) geographical identification schemes. Official indexes can be collected for each end user 358. Some official indexes, such as prisoner identification numbers or military service numbers, may be considered unique. Some official indexes, such as social security numbers, may be designed to be unique but, due to usage parameters, considered non-unique or non-universal.

A combination of demographic data, official indexes, and other indexes may be used to non-uniquely identify end users 358 in a data repository. For example, if only some of the information in an end user 358 is known, or if the full information identifies two or more end users, a user (human, computer, etc.) may be given multiple end users in response to a request for a single end user from a data repository.

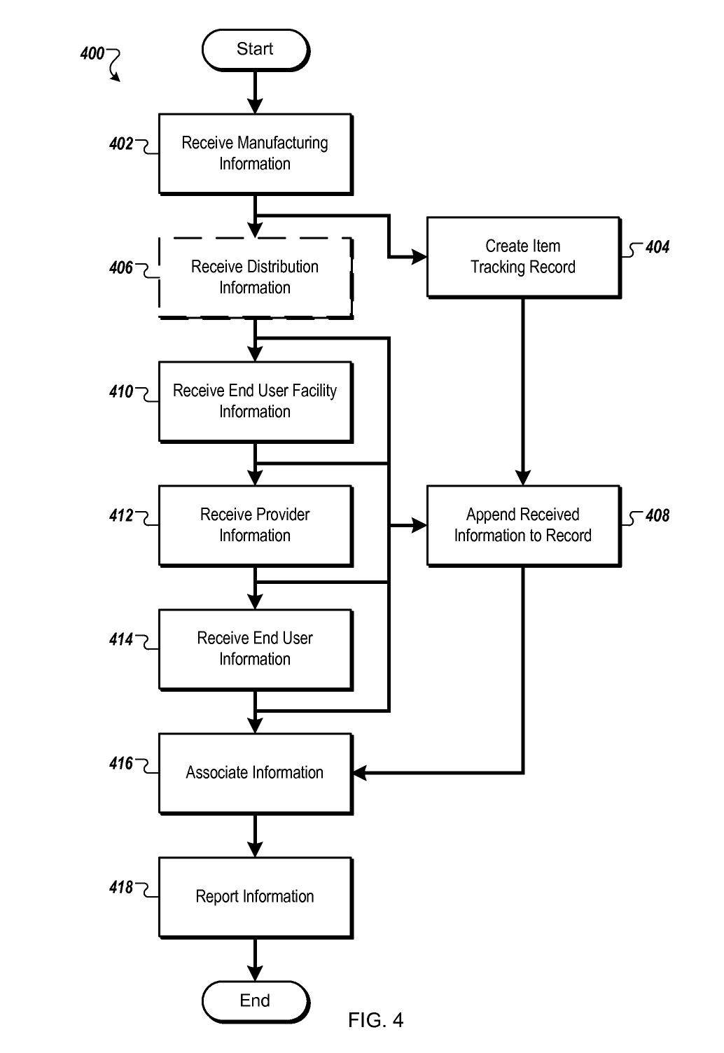

FIG. 4 is a flow chart showing an example process 400 of recording information related to an item and/or an end user. In some implementations, the process 400 can be performed by, for example, the item tracking system 100 and/or the cloud 200.

The process 400 can include receiving 402 manufacturing information about an item from an original manufacturer. In some implementations, the step 402 can be performed by the original manufacturer cloud 204 and/or the original manufacturer international cloud 214. For example, an original manufacturer can report the date, time, serial number, lot, shipment number, or other information about an item.

The process 400 can include creating 404 a item tracking record. In some implementations, the step 404 can be performed by the item cloud 204. For example, upon receipt 402 of manufacturing information, a data record related to the item can be created. Further data related to the item can be stored in or in relation to the item tracking record.

The process 400 can include receiving 406 distribution information about the item from a distributor. In some implementations, the step 406 can be performed by the distributor/end user facility cloud 206. For example, distribution facilities such as warehouses, supplemental manufacturing and processing facilities, or other facilities can receive the item. These facilities can report information similar to the original manufacturer and/or different information.

The process 400 can include appending 408 appending the reception information, association information, or end user information to the item tracking record. In some implementations, the step 408 can be performed by the item cloud 202. Upon receipt of information related to the item, the received information can be appended to the item tracking record associated with the item. In some implementations, a code such as described in described in FIG. 3 can be used to organize, store, and search for specific item tracking records.

The process 400 can include receiving 410 information about the item from an end user facility. In some implementations, the step 410 can be performed by the distributor/end user facility cloud 206. For example, an end user facility can report information about receiving the item, how and/or where it is stored, or other information.

The process 400 can include receiving 412 installation information about the item from a provider. In some implementations, the step 412 can be performed by the provider cloud 208. For example, information related to a medical procedure that includes the item can be reported. In some implementations, this information can include medical records related to the medical procedure that are not directly related to the item, such as medicine prescriptions, billing information, and/or provider instructions.

The process 400 can include receiving 414 end user information about the item from an end user. In some implementations, the step 402 can be performed by the end user cloud 210. For example, an end use can report their insurance, demographic, and/or contact information.

The process 400 can include associating 416 two or more of manufacturing information, distributing information, reception information, installation information, and end user information. In some implementations, the step 402 can be performed by the prevention cloud 212 and/or the outcomes cloud 216.

The process 400 can include reporting 418 information including at least a part of one of the manufacturing information, distribution information, reception information, installation information, and end user information. For example, end user information and installation information can be correlated to create a report that includes financial information for the purpose of executing a payment by a financial transaction cloud. The report can be sent to a financial institution such as the end user's bank for automatic bill payment.

In another example, a particular item can be found to be defective. In this example, a compilation can be generated by the outcomes cloud 216 of all facilities and people that have handled the item can be generated. A report detailing a count of the same or similar types of items that have been similarly handled and found defective can be generated. Using this report, faulty facilities and procedures can be located.

In another example, all end users associated with a provider can be identified by the outcomes cloud 216. A report listing anonymous information about the identified end users can be displayed. The report can show, for example, success rate of a procedure after six months, three years, or other time periods, the percentage of patients without insurance, or other information.

In another example, a patient can be prescribed a medicine that can produce an adverse reaction if taken with another medication prescribed to the same patient. The adverse reaction can be identified by the prevention cloud 212, and a report can be generated for the provider writing the prescription, the pharmacists filling either prescription, and/or the end user taking the medicine.

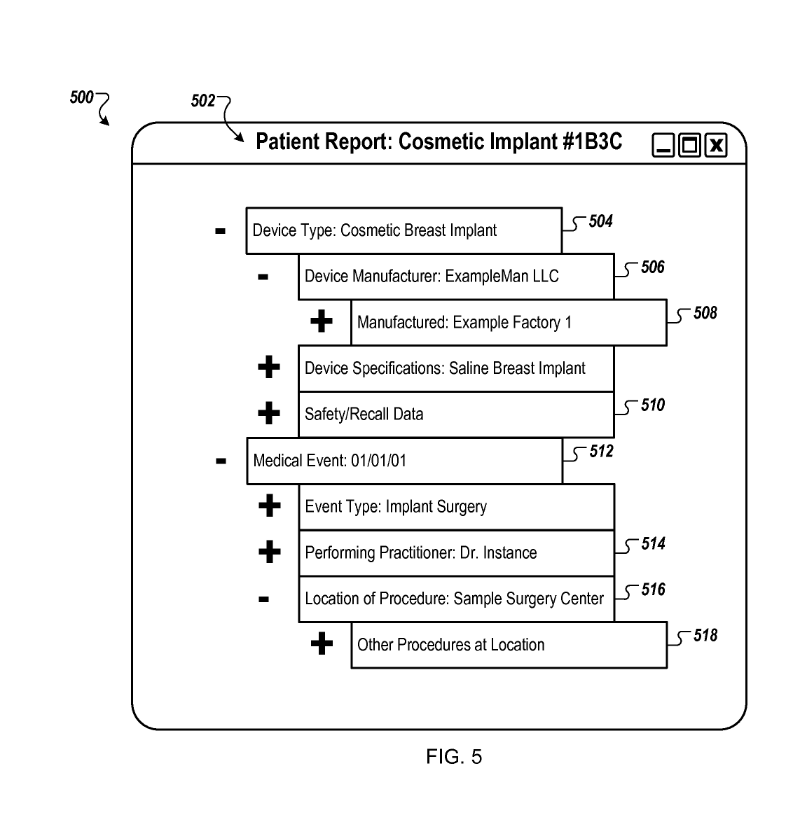

FIG. 5 shows an exemplary report 500 displaying medical information and associated details of a unique medical device and end user information. For example, the report 500 can show to an end user, such as a patient, information stored in a medical device tracking cloud related to a medical device used by the end user. The exemplary report 500 shown is a graphical user interface (GUI) that displays information in a collapsible tree structure. Alternative reports can be GUIs that display information in a different format, including but not limited to a grid, list, text summary or other format. Alternative reports can include printed information on a page, data saved to computer readable medium, audio reports, or other configurations.

The report 500 can have a title 502 indicating the purpose of the report, for example including the intended reader and type of data displayed. The data presented in the report 500 can be directly or indirectly related to the title.

Data 504 can be a base or primary piece of data, for example a listing of a type of medical device described in the report. Data 506 can be data classified or organized related to or subordinate to the data 504, for example the name of the company that manufactured the medical device described in the report. Data 510 can also be data classified or organized related to or subordinate to the data 504, for example safety and recall data associated with the medical device. Data 508 can be data classified or organized related to or subordinate to the data 506, for example the location of the facility that manufactured the medical device can be listed. In some implementations, additional data can be shown or hidden if the report 500 receives input such as a mouse click on the “+” or “−” signs in the data 504-518. For example, additional information can be hidden under the data 508 that can include information about distributors that have handled the medical device.

Data related to a medical device can be displayed in the report 500 in a format unrelated to the form the data may take while stored in a computational cloud, database, or other data storage system. For example, data 512 can be information about a medical procedure performed by an provider, such as a surgeon. Data 514 can be additional information about the provider and can be displayed under the data 512. Data 516 can be information about the end user facility, such as a clinic, where the provider implanted the medical device in the patient. The data 514 and the data 516 can be displayed under the data 512 even though they can be stored in a different manor or relationship in a computational cloud.

Relationships, such as hypertext links, to related data can be displayed in the report 500. For example, the data 518 can include a hypertext link to another report that contains informational about the provider listed in the data 512.

Additional data can be included in the report 500. The additional data can include end user log-in information, references to related information based on information provided, and/or other information.

The report 500 can be altered to hide or anonymize some or all of the data. For example, the report 500 can remove the data 514-518. In this example, a modified report 500 can be suitable for release to and/or use by a researcher collecting data related to the medical device described in the data 504.

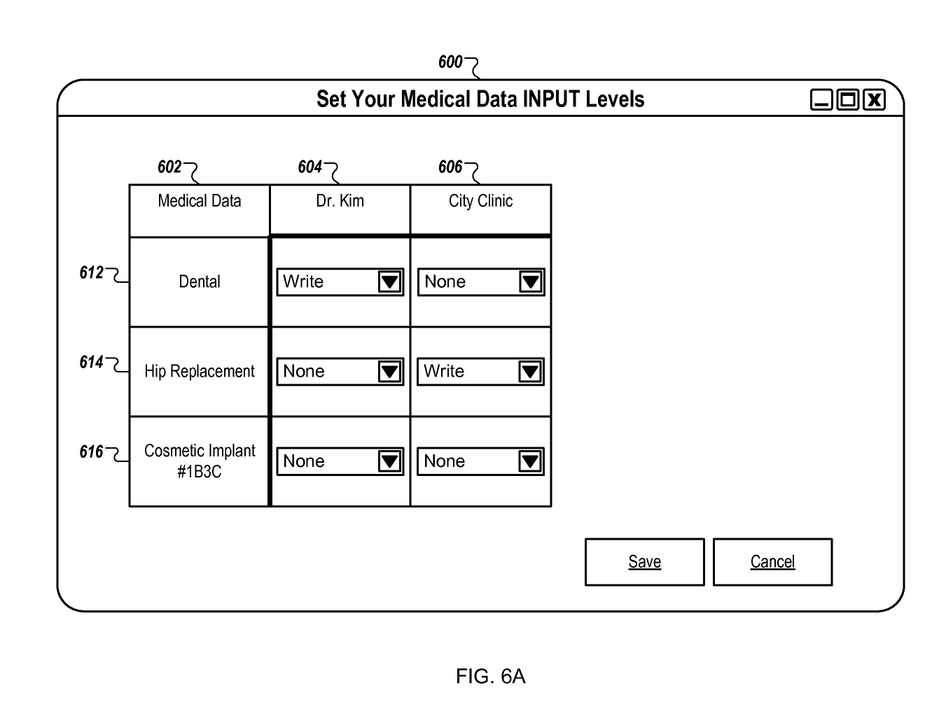

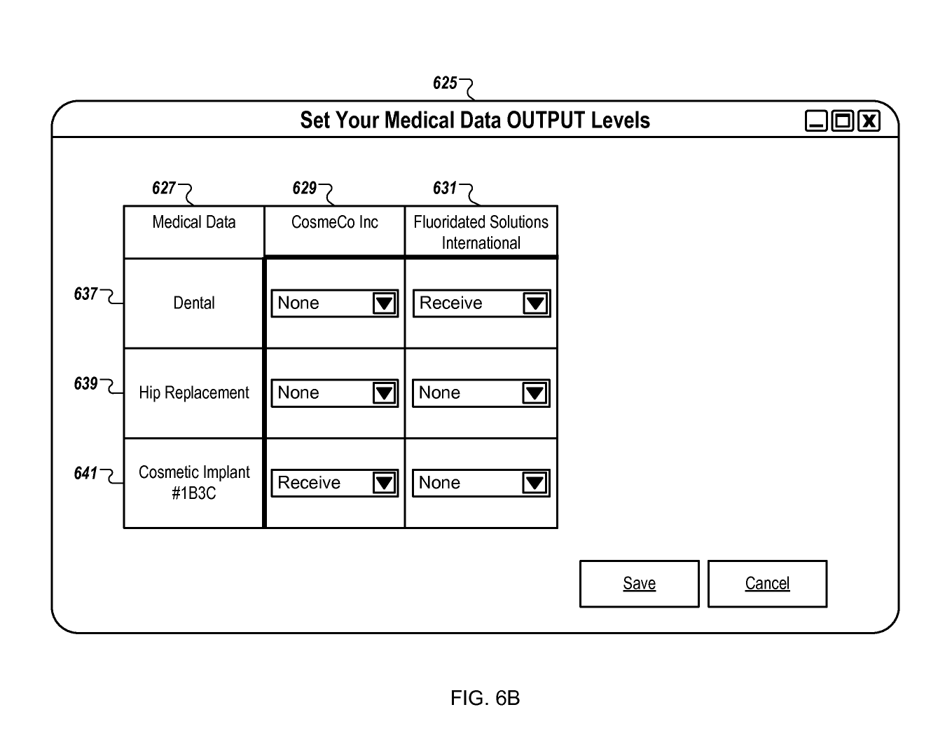

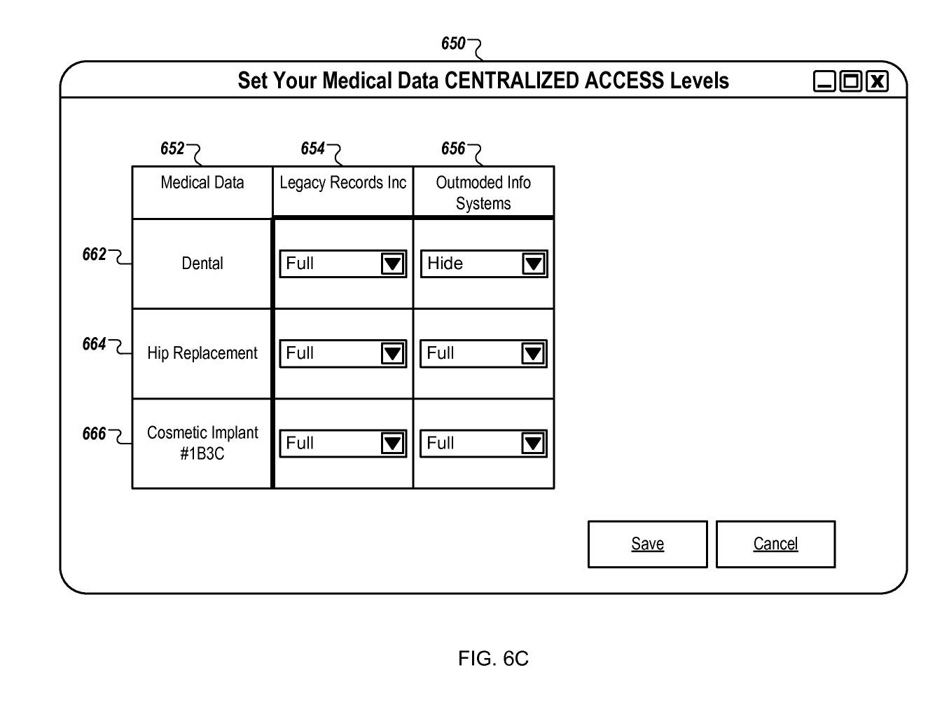

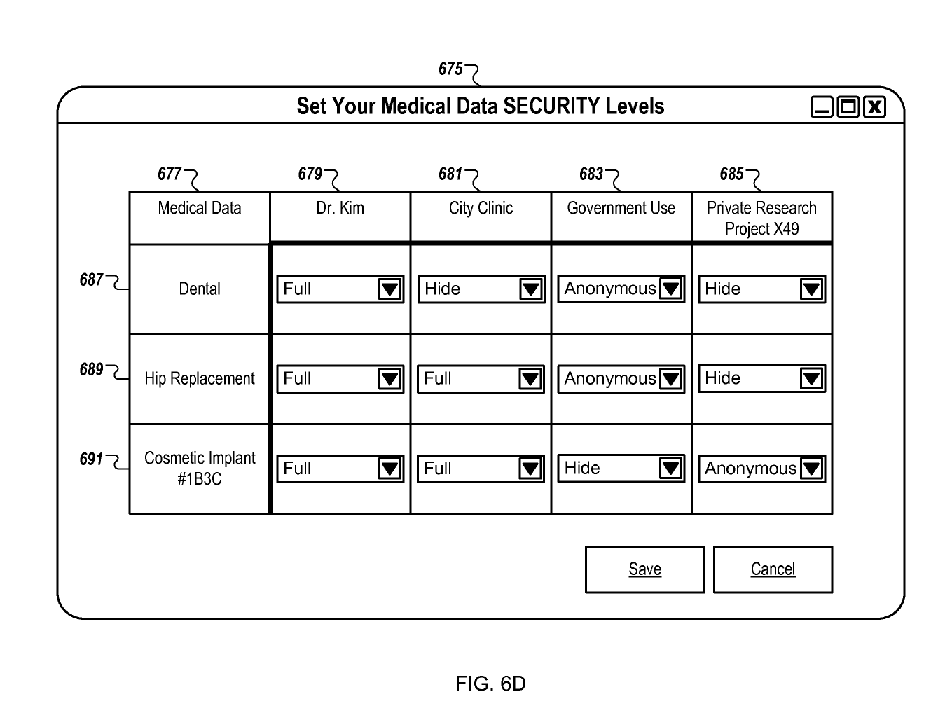

FIG. 6A shows an exemplary graphical user interface 600 for setting input access levels. For example, the GUI 600 can be a webpage, application interface, or other method of receiving information from a user. The GUI 600 can be used to, for example, set permissions to enter and edit medical records related to a patient.

In one implementation, collections of medical data can be grouped based on type and displayed in a column 602. Parties that may receive access to the medical data in the column 602 can be displayed in additional columns 604 and 606.

In one implementation, dentists can be displayed in the column 604; a primary care clinic can be displayed in the column 606. In other configurations, interested groups can include government bodies such as the Food and Drug Administration, Health and Human Serves, or non-governmental bodies such as independent medical research organizations, polling organizations, families, or other groups.

Medical data can be sorted into logical categories and displayed in rows. In one implementation, dental medical records can be displayed in the row 612, hip replacement records, including device tracking information related to the hip implant, can be displayed in row 614, and data relating to an implant that has been removed from the patient can be shown in the row 616.

Row/column intersections in the GUI 600 can include drop-down boxes for selecting data access. Optional choices in the drop-down box can include write access to associated medical records, or no write access to associated records. In one configuration, the intersection of the column 604 and the row 612 can represent the full write access that the dentist Dr. Kim can have to all of the user's dental records. In another configuration, the intersection of the column 606 and the row 616 can represent the denial of write access that the City Clinic can have to a cosmetic implant that was implanted and removed by a provider in a different clinic.

FIG. 6B shows an exemplary graphical user interface 625 for setting output access levels. For example, the GUI 625 can be a webpage, application interface, or other method of receiving information from a user. The GUI 625 can be used to, for example, set permissions to send medical records related to a patient to an organization that has manufactured, distributed, stored, or tracked a medical device associated with a patient.

In one implementation, collections of medical data can be grouped based on type and displayed in a column 627. Parties that may receive access to the medical data in the column 627 can be displayed in additional columns 629 and 631.

In one implementation, cosmetic implant manufacturer can be displayed in the column 629, and a dental medicine consulting firm can be displayed in the column 631. In other configurations, interested groups can include government bodies such as the Food and Drug Administration, Health and Human Serves, or non-governmental bodies such as independent medical research organizations, polling organizations, families, or other groups.

Medical data can be sorted into logical categories and displayed in rows. In one implementation, dental medical records can be displayed in the row 637, hip replacement records, including device tracking information related to the hip implant, can be displayed in row 639, and data relating to an implant that has been removed from the patient can be shown the row 641.

Row/column intersections in the GUI 625 can include drop-down boxes for selecting data access. Optional choices in the drop-down box can include output reception access to associated medical records, or no output reception access to associated records. In one configuration, the intersection of the column 629 and the row 641 can represent the full output reception access that the cosmetic manufacturer CosmeCo Inc can have to all of the user's dental records. In another configuration, the intersection of the column 631 and the row 641 can represent the denial of output reception access that Fluoridated Solutions International can have to a cosmetic implant unrelated to dental medicine.

FIG. 6C shows an exemplary graphical user interface 675 for setting centralized access levels. For example, the GUI 650 can be a webpage, application interface, or other method of receiving information from a user. The GUI 650 can be used to, for example, set permissions to send medical records related to a patient to an external medical records tracking system or present to release centralized medical information in a medical emergency to an authorized provider or emergency associate.

In one implementation, collections of medical data can be grouped based on type and displayed in a column 652. Parties that may receive access to the medical data in the column 652 can be displayed in additional columns 654 and 656.

In one implementation, a first legacy medical records system can be displayed in the column 654, and a second legacy medical records system can be displayed in the column 656. In other configurations, interested groups can include government bodies such as the Food and Drug Administration, Health and Human Serves, or non-governmental bodies such as independent medical research organizations, polling organizations, families, or other groups.

Medical data can be sorted into logical categories and displayed in rows. In one implementation, dental medical records can be displayed in the row 662, hip replacement records, including device tracking information related to the hip implant, can be displayed in row 664, and data relating to an implant that has been removed from the patient can be shown the row 666.

Row/column intersections in the GUI 650 can include drop-down boxes for selecting data access. Optional choices in the drop-down box can include output reception access to associated medical records, or no output reception access to associated records. In one configuration, the intersection of the column 654 and the row 666 can represent the full output reception access that the first legacy medical records system can have to all of the user's dental records. In another configuration, the intersection of the column 656 and the row 666 can represent the denial of output reception access that the second legacy medical records system can have to a cosmetic implant unrelated to dental medicine.

FIG. 6D shows an exemplary graphical user interface 650 for setting security access levels. For example, the GUI 675 can be a webpage, application interface, or other method of receiving information about a user. The GUI 675 can be used to, for example, set privacy and read access levels to medical records.

In one implementation, collections of medical data can be grouped based on type and displayed in a column 677. Parties that may receive access to the medical data in the column 677 can be displayed in additional columns 679-685. In one implementation, dentists can be displayed in the column 679, a primary care clinic can be displayed in the column 681, an interested group such as a government agency can be displayed in the column 683, and a particular research project can be displayed in the column 685. In other configurations, interested groups can include government bodies such as the Food and Drug Administration, Health and Human Serves, or non-governmental bodies such as independent medical research organizations, polling organizations, families, or other groups.

Medical data can be sorted into logical categories and displayed in rows. In one implementation, dental medical records can be displayed in the row 687, hip replacement records, including device tracking information related to the hip implant, can be displayed in row 689, and data relating to an implant that has been removed from the patient can be shown the row 691.

Row/column intersections in the GUI 675 can include drop-down boxes for selecting data access. Optional choices in the drop-down box can include full read access to associated data, anonymous access that does not include identifying data, or hiding or preventing access that prevents the party from being aware of or accessing the data. In one configuration, the intersection of the column 679 and the row 687 can represent the full access which the dentist Dr. Kim can have to all of the user's dental records. In another configuration, the intersection of the column 685 and the row 691 can represent the anonymous access that the members of research project X49 can have to the removed implant.

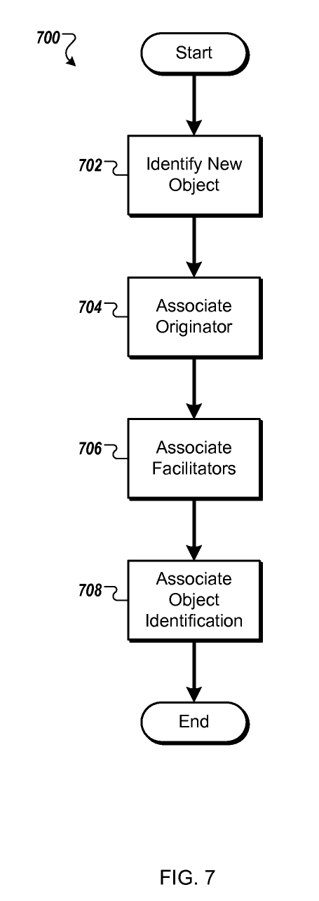

FIG. 7 is a flow chart showing an example process 700 of adding new data to a tracking system. In some implementations, the process 700 can be performed by, for example, the item tracking system 100 and/or the cloud 200.

The process 700 can include identifying 702 a new object to be tracked. For example, a new object may come into being or into a state such that it can be tracked by a tracking system. Records, data fields, memory objects, or other object of the tracking system can be created in preparation for receiving information about the new object.

The process 700 can include associating 704 an originator to the new object. For example, a tracking system can track a new object as well as people, places, or other information associated with creation or transformation of the new object.

The process 700 can include associating 706 one or more facilitators to the new object. For example, a tracking system can track a new object; the people, places, or other information associated with the creation or transformation of the new object; and people, places, or other information associated with facilitators that have altered or assisted with the creation or transformation of the new object.

The process 700 can include associating 708 object identification codes to the new object. For example, a new object can be identified in a tracking system using a code that includes references to one or more originators, one or more facilitators, and an object code.

In one implementation, a mother may deliver a baby in a hospital with the aid of a provider. In this implementation, the baby can be tracked by a medical device and medical patient tracking system. The mother can be associated with the baby in the medical device and medical patient tracking system as a manufacturer and end user (otherwise known as an originator). The hospital can be associated with the baby in the medical device and medical patient tracking system as a end user facility (otherwise known as a facilitator). The provider can be associated with the baby in the medical device and medical patient tracking system as a provider (otherwise known as a facilitator). In this implementation, a code identifying the baby in the medical device and medical patient tracking system can be generated that includes codes identifying the originator, the hospital, the provider, and that includes a PIN chosen by the originator, and secret by, for example, the newborn baby's legal guardian and enables a new unique identification and origination of elective medical records at birth, or prior to birth, using numbers in code.

In another implementation, a medical device can be manufactured by an original manufacturer, crated by a distributor, and prescribed by a doctor. The original manufacturer can be associated with the medical device in the medical device and medical patient tracking system as an originator. The distributor can be associated with the medical device in the medical device and medical patient tracking system as a facilitator. The provider can be associated with the medical device in the medical device and medical patient tracking system as a facilitator. In this implementation, a code identifying the medical device in the medical device and medical patient tracking system can be generated that includes codes identifying the originator, and the facilitators, and includes a medical device serial number generated by the originator and provided to third parties for cataloging and safety checks.

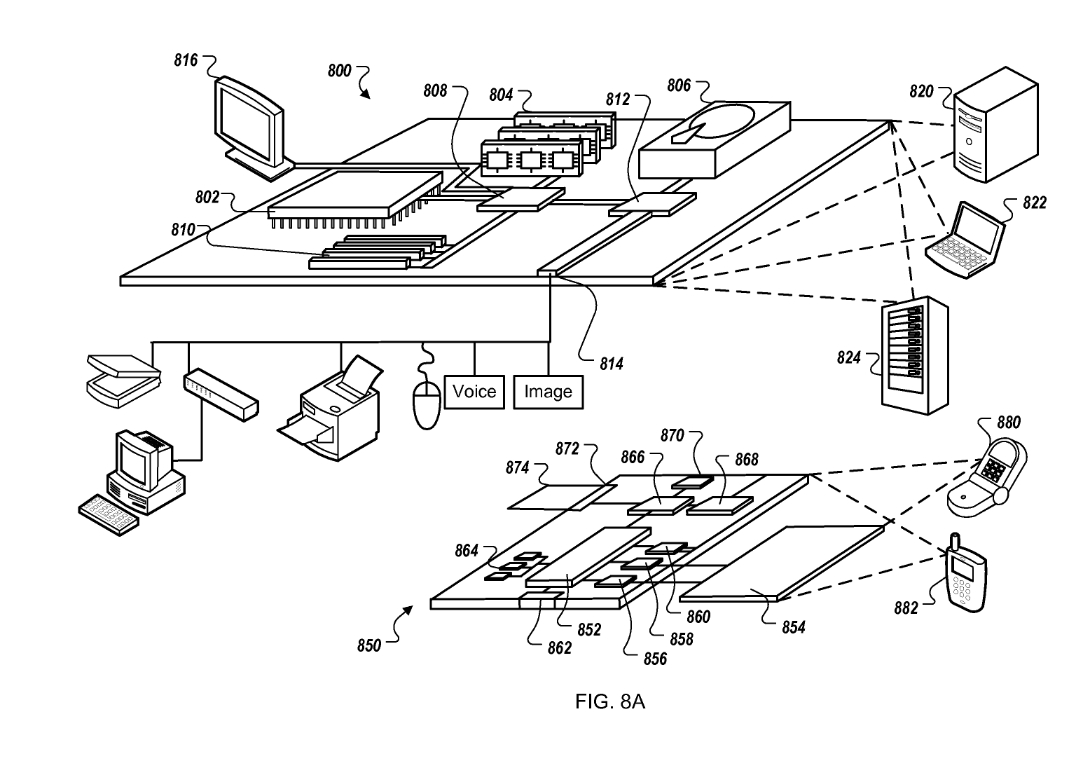

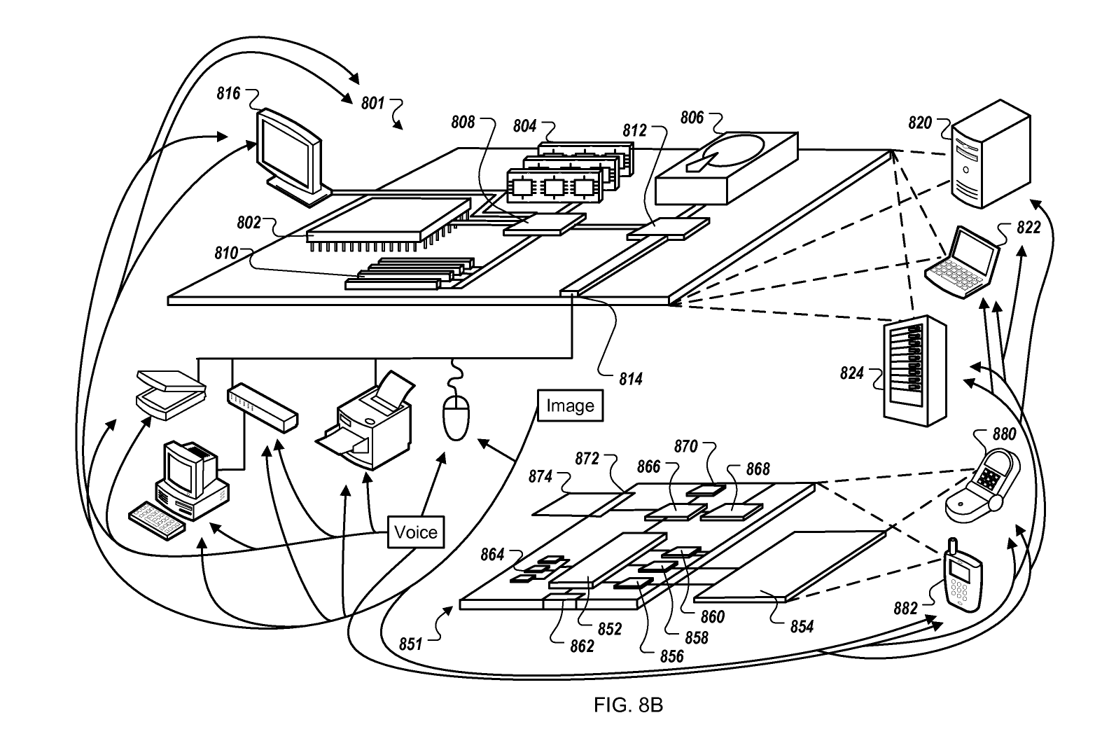

FIG. 8A shows an example of a computing device 800 and a mobile computing device that can be used to implement the techniques described here. The computing device 800 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, and other similar computing devices. The components shown in FIG. 8A, their connections and relationships, and their functions, are meant to be exemplary only, and are not meant to limit implementations of the inventions described and/or claimed in this document. Any and all forms of computing devices can be implemented to centralize, merge, upload, transfer, download, associate, or manage new or existing information, including sound an image data, and data in real time.

The computing device 800 can include a processor 802, a memory 804, a storage device 806, a high-speed interface 808 connecting to the memory 804 and multiple high-speed expansion ports 810, and a low-speed interface 812 connecting to a low-speed expansion port 814 and the storage device 806. Each of the processor 802, the memory 804, the storage device 806, the high-speed interface 808, the high-speed expansion ports 810, and the low-speed interface 812, are interconnected using various buses, and may be mounted on a common motherboard or in other manners as appropriate. The processor 802 can process instructions for execution within the computing device 800, including instructions stored in the memory 804 or on the storage device 806 to display graphical information for a GUI on an external input/output device, such as a display 816 coupled to the high-speed interface 808. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 804 stores information within the computing device 800. In some implementations, the memory 804 is a volatile memory unit or units. In some implementations, the memory 804 is a non-volatile memory unit or units. The memory 804 may also be another form of computer-readable medium, such as a magnetic or optical disk.

The storage device 806 is capable of providing mass storage for the computing device 800. In some implementations, the storage device 806 may be or may contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The computer program product can also be tangibly embodied in a computer- or machine-readable medium, such as the memory 804, the storage device 806, or memory on the processor 802.

The high-speed interface 808 manages bandwidth-intensive operations for the computing device 800, while the low-speed interface 812 manages lower bandwidth-intensive operations. Such allocation of functions is exemplary only. In some implementations, the high-speed interface 808 is coupled to the memory 804, the display 816 (e.g., through a graphics processor or accelerator), and to the high-speed expansion ports 810, which may accept various expansion cards (not shown). In this implementation, the low-speed interface 812 is coupled to the storage device 806 and the low-speed expansion port 814. The low-speed expansion port 814, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 800 may be implemented in a number of different forms, as shown in the figure. For example, it may be implemented as a standard server 820, or multiple times in a group of such servers. In addition, it may be implemented in a personal computer such as a laptop computer 822. It may also be implemented as part of a rack server system 824. It may also be implemented as part of a kiosk or public use center. Alternatively, components from the computing device 800 may be combined with other components in a mobile device (not shown), such as a mobile computing device 850. Each of such devices may contain one or more of the computing device 800 and the mobile computing device 850, and an entire system may be made up of multiple computing devices communicating with each other.

The mobile computing device 850 includes a processor 852, a memory 864, an input/output device such as a display 854, a communication interface 866, and a transceiver 868, among other components. The mobile computing device 850 may also be provided with a storage device, such as a micro-drive or other device, to provide additional storage. Each of the processor 852, the memory 864, the display 854, the communication interface 866, and the transceiver 868, are interconnected using various buses, and several of the components may be mounted on a common motherboard or in other manners as appropriate.

The processor 852 can execute instructions within the mobile computing device 850, including instructions stored in the memory 864. The processor 852 may be implemented as a chipset of chips that include separate and multiple analog and digital processors. The processor 852 may provide, for example, for coordination of the other components of the mobile computing device 850, such as control of user interfaces, applications run by the mobile computing device 850, and wireless communication by the mobile computing device 850.

The processor 852 may communicate with a user through a control interface 858 and a display interface 856 coupled to the display 854. The display 854 may be, for example, a TFT (Thin-Film-Transistor Liquid Crystal Display) display or an OLED (Organic Light Emitting Diode) display, or other appropriate display technology. The display interface 856 may comprise appropriate circuitry for driving the display 854 to present graphical and other information to a user. The control interface 858 may receive commands from a user and convert them for submission to the processor 852. In addition, an external interface 862 may provide communication with the processor 852, so as to enable near area communication of the mobile computing device 850 with other devices. The external interface 862 may provide, for example, for wired communication in some implementations, or for wireless communication in other implementations, and multiple interfaces may also be used.

The memory 864 stores information within the mobile computing device 850. The memory 864 can be implemented as one or more of a computer-readable medium or media, a volatile memory unit or units, or a non-volatile memory unit or units. An expansion memory 874 may also be provided and connected to the mobile computing device 850 through an expansion interface 872, which may include, for example, a SIMM (Single In Line Memory Module) card interface. The expansion memory 874 may provide extra storage space for the mobile computing device 850, or may also store applications or other information for the mobile computing device 850. Specifically, the expansion memory 874 may include instructions to carry out or supplement the processes described above, and may include secure information also. Thus, for example, the expansion memory 874 may be provide as a security module for the mobile computing device 850, and may be programmed with instructions that permit secure use of the mobile computing device 850. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, a computer program product is tangibly embodied in an information carrier. The computer program product contains instructions that, when executed, perform one or more methods, such as those described above. The computer program product can be a computer- or machine-readable medium, such as the memory 864, the expansion memory 874, or memory on the processor 852. In some implementations, the computer program product can be received in a propagated signal, for example, over the transceiver 868 or the external interface 862.

The mobile computing device 850 may communicate wirelessly through the communication interface 866, which may include digital signal processing circuitry where necessary. The communication interface 866 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 868 using a radio-frequency. In addition, short-range communication may occur, such as using a Bluetooth, WiFi, or other such transceiver (not shown). In addition, a GPS (Global Positioning System) receiver module 870 may provide additional navigation- and location-related wireless data to the mobile computing device 850, which may be used as appropriate by applications running on the mobile computing device 850.

The mobile computing device 850 may also communicate audibly using an audio codec 860, which may receive spoken information from a user and convert it to usable digital information. The audio codec 860 may likewise generate audible sound for a user, such as through a speaker, e.g., in a handset of the mobile computing device 850. Such sound may include sound from voice telephone calls, may include recorded sound (e.g., voice messages, music files, etc.) and may also include sound generated by applications operating on the mobile computing device 850.

The mobile computing device 850 may be implemented in a number of different forms, as shown in the figure. For example, it may be implemented as a cellular telephone 880. It may also be implemented as part of a smart-phone 882, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, image, or tactile input. For example, medical measurement devices such as blood pressure monitors can provide input to the computer.

FIG. 8B shows and alternative example of a computing device 801 and a mobile computing device 851 that can be used in connection with computer-implemented methods and systems described in this document.

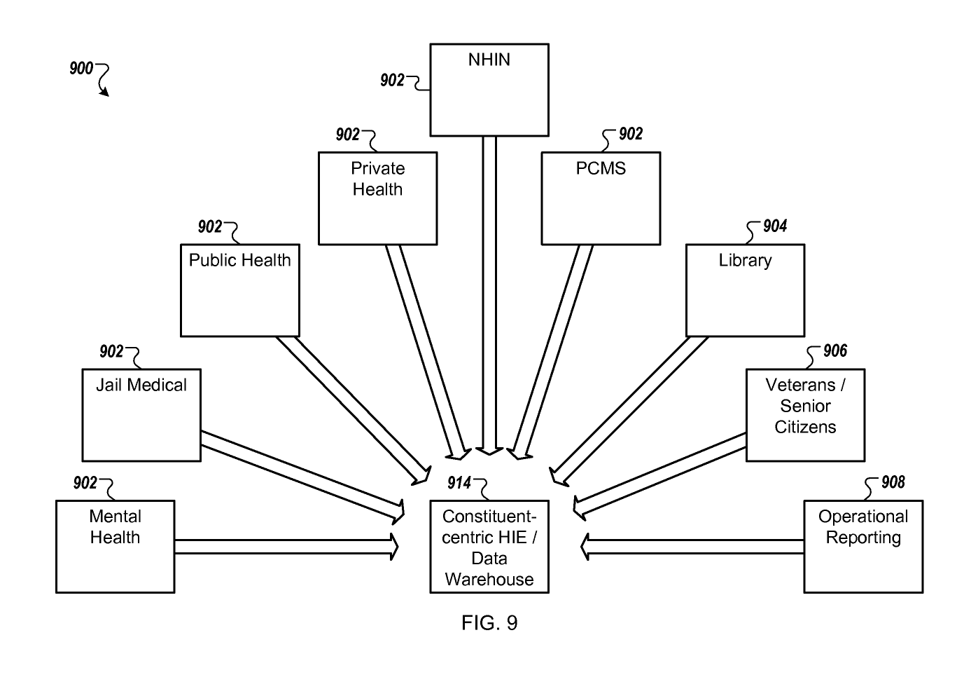

FIG. 9 shows a computer system for collecting data from record holders to a data repository. A data warehouse 914 can collect and aggregate records, for example records relating to end users of a medical data system. The records collected can be indexed according to, for example, the index listings in FIG. 3B.

Health related institutions 902 can collect and organize patient medical records. Each health related institution 902 can use a different coding, indexing, and storage scheme, resulting in records held in different data formats, even when those records hold the same or similar information. Example health related instructions can include mental health facilities, jail medical facilities, public health organizations (e.g., public hospitals and practices, etc.), private health organizations (e.g., private hospitals and practices, etc.), and patient care management services (e.g., insurance or third party medical records aggregators, etc.).

Libraries 904 can hold medial research, information, and news. For example, one library 904 may contain a data set of known drug interactions recorded in a first data format. A second library 904 may contain a listing of recalled items.

Government record repositories 906 may be collected from medical assistance programs (e.g., for veterans, senior citizens, means-tested assistance, etc.) In some implementations, multiple such government record repositories 906 may share data formats and interfaces.

Operational reporting modules 908 may contain definitions of reports that can be run against a data in the data warehouse 914. In some implementations, previous reports using different data sets can be translated to be run against the data in the data warehouse 914.

The data warehouse 914 can receive or fetch data from each data source 902-908. In some examples, the frequency and nature of such receptions or fetches can be determined by the legal, business, or technological relationship between the data warehouse 914 and the data sources 902-908. These relationships may vary by data source 902-908. As data is imported cataloging information, such as described in FIG. 3A, and indexing data, such as described in FIG. 3B, may be applied to the data. As such, data in the data warehouse 914 may all be referenced by a single indexing scheme, even if the data in the data sources 902-908 is not.

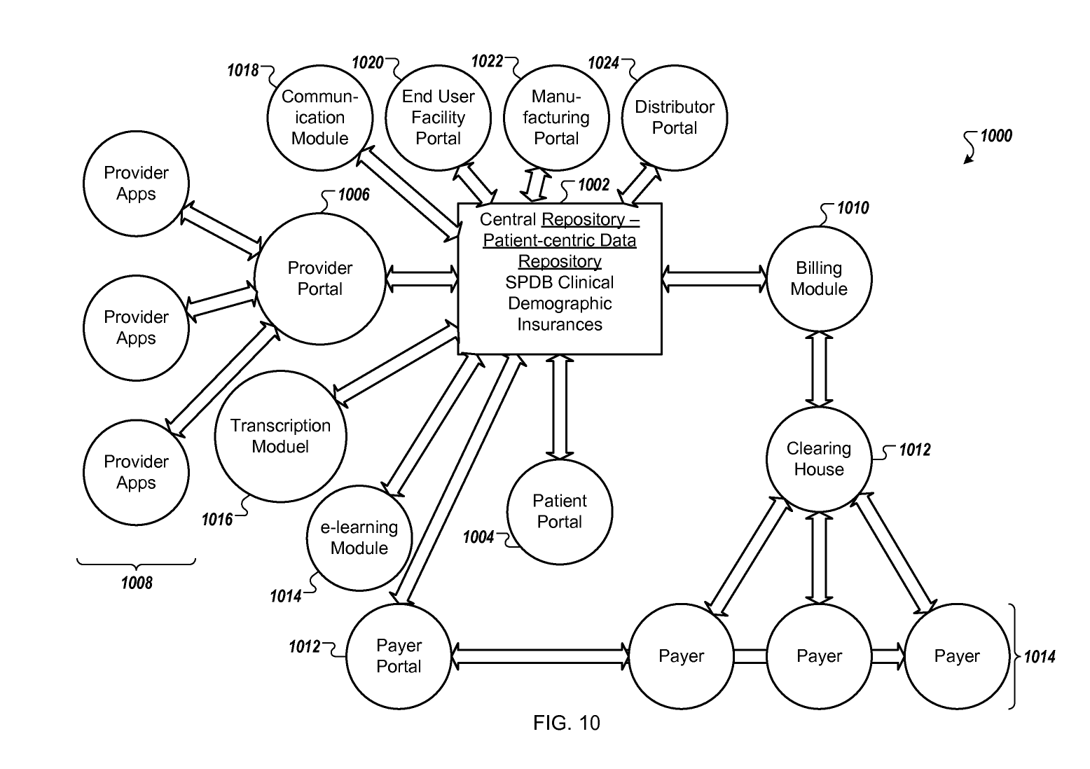

FIG. 10 shows a computer system for providing information from a data repository to user portals.

A data repository 1002 can collect data from record holders, and organize and index those data records according to an indexing scheme. Data in data repository can include item tracking information, including manufacture, distribution, use, and results. Data in the data repository can also include information about humans, including practitioners and patients a medical tracking system.

A patient portal 1004 can provide access to data in the data repository 1002 to patients. In some implementations, the patient portal can display graphical user interfaces to set input access levels, set output access levels, centralized access levels, and security levels relating to data associated with a patient. The patient portal 1004 can also present the medical history of a patient to the patient.

Web applications for providers 1006 can provide applications to providers to interact with data in the data repository 1002. The web applications for providers 1006 can include applications created by the owners and operators of the data repository 1002, including the ability to upload and access patient data for patients that are associated with that particular provider. Additionally, the web applications for providers 1006 can provide an application programming interface (API) to third party provider applications 1008 to access the data warehouse 1002. The third party provider applications 1008 may be created by third parties to support the practice of providers based on the particular requirements and objectives of a particular provider.

A billing module 1010 can provide access to financial transactions in the data repository 1002. In some implementations, the billing module 1010 can observe changes in the data warehouse 1002 and identify events that generate a financial event (e.g., a procedure by a provider for a patient that generates a bill, etc.) The billing module 1010 can send the financial events to a clearing house 1012, which can aggregate the billing events into bills associated with providers and patients. Payers 1014, for example patients, insurers, and government entities, can pay the bills created by the clearing house 1012.

A payer portal 1012 can provide a payer 1014 access to some or all of the outstanding and/or completed financial information associated with the payer 1014. An e-learning module 1014 can provide e-learning services to a user. A transcription module 1016 can provide transcription services to users. A communications module 1018 can provide communication services (e.g., email, telephone messaging, etc.) to users. An end user facility portal can provide users at an end user facility with controlled access the data repository 1002. A manufacturing portal 1022 can provide users at a manufacturer with controlled access the data repository 1002. A distributor portal 1024 can provide users at a distributor with controlled access the data repository 1002. In some implementations, all portals can or are interoperable.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications can be made without departing from the spirit and scope of this disclosure. Accordingly, other embodiments are within the scope of the following claims.

Although a particular order, number, and type of steps have been described, it will be understood that other processes are possible that include more, fewer, and/or different steps than those shown.

What is claimed is:

1. A computer system for tracking data, the computer system being implemented in computer-readable medium and processor executed, the computer system comprising:
a data collection system for identifying events of categories including reception events, storage events, and association events;
an item module containing index data for an item;
an end user facility module for recording the reception events that are to be assigned to the item and the storage events that are to be assigned to the item;
a provider module for assigning the association events to a provider;
an end user module for recording the association events that are to be assigned to the end user and to the item; and
a reporting system for generating reports comprising information from at least two of the categories,
wherein the item has a unique index value and the end user has a non-unique index value; and
wherein at least the end user facility module, the provider module, and the end user module are communicably coupled to each other in the computer system by a computer network.

2. The computer system of claim 1, further comprising a manufacturer module for recording the manufacturing events that are to be assigned to the item;
wherein the reporting system generates reports comprising information from at least one of the categories and a manufacturing event; and
wherein the manufacturing module is communicably coupled to the computer network.

3. The computer system of claim 1, wherein the item is a medical device.

4. The computer system of claim 1, further comprising a distributor module for recording distribution events that are to be assigned to the item;
wherein the reporting system generates reports comprising information from at least one of the categories and a distribution event; and
wherein the distributor module is communicably coupled to the computer network.

5. The computer system of claim 1, wherein the end user's non unique index includes demographic information.

6. The computer system of claim 1, wherein the item's unique index includes a model number and serial number.

7. The computer system of claim 1, wherein the end user facility module is associated with one or more of a hospital, clinic, or health care office.

8. The computer system of claim 1, wherein the provider module is associated with a health care provider.

9. The computer system of claim 1, wherein the end user is a medical patient.

10. A method for tracking data, the method being implemented in computer readable medium and processor executed, the method comprising:
identifying, by a data collection system, events of categories including reception events, storage events, and association events;
accessing, from an item module, index data for an item;
recording, by an end user facility module, the reception events that are to be assigned to the item and the storage events that are to be assigned to the item;
assigning, by a provider module, the association events to a provider;
recording, by an end user module, the association events that are to be assigned to the end user and to the item;
generating, by a reporting system, reports comprising information from at least two of the categories;
wherein the item has a unique index value and the end user has a non-unique index value; and
wherein at least the end user facility module, the provider module, and the end user module are communicably coupled to each other in the computer system by a computer network.

11. The method of claim 10, further comprising recording, by a manufacturer module, the manufacturing events that are to be assigned to the item;
generating, by a reporting system, reports comprising information from at least one of the categories and a manufacturing event; and
wherein the manufacturing module is communicably coupled to the computer network.

12. The method of claim 10, wherein the item is a medical device.

13. The method of claim 10, further comprising recording, by a distributor module, distribution events that are to be assigned to the item;
generating, by a reporting system, reports comprising information from at least one of the categories and a distribution event; and
wherein the distributor module is communicably coupled to the computer network.

14. The method of claim 10, wherein the end user's non unique index includes demographic information.

15. The method of claim 10, wherein the item's unique index includes a model number and serial number.

16. The method of claim 10, wherein the end user facility module is associated with one or more of a hospital, clinic, or health care office.

17. The method of claim 10, wherein the provider module is associated with a health care provider.

18. The method of claim 10, wherein the end user is a medical patient.

19. A computer program product tangibly embodied in a computer readable storage medium and comprising instructions that when executed by a processor perform a method comprising:
identifying, by a data collection system, events of categories including reception events, storage events, and association events;
accessing, from an item module, index data for an item;
recording, by an end user facility module, the reception events that are to be assigned to the item and the storage events that are to be assigned to the item;
assigning, by a provider module, the association events to a provider;
recording, by an end user module, the association events that are to be assigned to the end user and to the item;
generating, by a reporting system, reports comprising information from at least two of the categories;
wherein the item has a unique index value and the end user has a non-unique index value; and
wherein at least the end user facility module, the provider module, and the end user module are communicably coupled to each other in the computer system by a computer network.

20. The computer program product of claim 19, wherein the method further comprises recording, by a manufacturer module, the manufacturing events that are to be assigned to the item;
generating, by a reporting system, reports comprising information from at least one of the categories and a manufacturing event; and
wherein the manufacturing module is communicably coupled to the computer network.

21. The computer program product of claim 19, wherein the item is a medical device.

22. The computer program product of claim 19 wherein the method further comprises recording, by a distributor module, distribution events that are to be assigned to the item;
generating, by a reporting system, reports comprising information from at least one of the categories and a distribution event; and
wherein the distributor module is communicably coupled to the computer network.

23. The computer program product of claim 19, wherein the end user's non unique index includes demographic information.

24. The computer program product of claim 19, wherein the item's unique index includes a model number and serial number.

25. The computer program product of claim 19, wherein the end user facility module is associated with one or more of a hospital, clinic, or health care office.

26. The computer program product of claim 19, wherein the provider module is associated with a health care provider.

27. The computer program product of claim 19, wherein the end user is a medical patient.
